(19) United States
(12) Patent Application Publication
(10) Pub. No.: US 2019/0248960 A1
(43) Pub. Date: Aug. 15, 2019

(54) Use of a Polymeric Polyphosphite as a Polymer Processing Aid

(71) Applicant: Dover Chemical Corporation, Dover, OH (US)

(72) Inventors: Michael R Jakupca, Canton, OH (US); Jacob M. Lance, Dover, OH (US); John T. Regula, Baltic, OH (US)

(73) Assignee: Dover Chemical Corporation, Dover, OH (US)

(21) Appl. No.: 15/896,119

(22) Filed: Feb. 14, 2018

(51) Int. Cl. C08G 79/04; C08G 73/02; C08L 23/00; C08L 85/02

(52) U.S. Cl. CPC C08G 79/04; C08L 85/02; C08L 23/00; C08G 73/024

(57) ABSTRACT

The invention pertains generally to a polymer composition comprising a certain secondary anti-oxidant, that can also act as a polymer processing aid alone or in combination with another polymer processing aid.

### TECHNICAL FIELD

The invention described herein pertains generally to a polyolefin resin composition containing certain polymeric polyphosphites alone or in combination with another polymer processing aid. The combination of these two additives results in enhanced processing during melt extrusion.

### BACKGROUND OF THE INVENTION

Organic phosphites are known for their anti-oxidant properties when added to polymers and other organic materials. The main purpose associated with the addition of a phosphites stabilizer to a polymeric resin is to prevent deterioration of the polymer during processing at high temperature. Polymer processing aids are used to improve the melt processing of polyolefins by reducing melt fracture. To increase the throughput of a resin during extrusion, one generally increases the speed of the screw. However, the viscoelastic behavior of the polymer melt, sets limits and if extrusion rates exceed a certain value, defects known as “melt fracture” occur on the surface of the extruded material. Use of processing aids helps to reduce or eliminate melt fracture, which is also known as “sharkskin”. Use of processing aids can result in increasing through-put and reducing sharkskin. There is a good deal of literature and patents on processing aids: (e.g., U.S. Pat. Nos. 3,125,547; 6,774,164; 6,610,408; 5,830947; 7,662,324, 8,110,262; and WO2011/017021A1). The most common processing aids are fluoropolymers. Fluoropolymers are expensive additives and may be less effective in the presence of filler. For economic reasons, there is a desire to increase production rates for polyethylene products based on blow film and blow-molded process.

### SUMMARY OF THE INVENTION

The present invention is directed to a polyolefin resin composition comprising a fluorine containing polymer processing aid and a second processing additive (a polymeric polyphosphite) that also is a polymer stabilizer. These polyolefin compositions have improved resistance to melt fracture during melt processing than other polyolefin compositions containing the fluorine processing aid and any other phosphite stabilizer.

These and other objects of this invention will be evident when viewed in light of the drawings, detailed description and appended claims.

### BRIEF DESCRIPTION OF THE DRAWINGS

FIG. 1 is plot of the impact of various phosphites over time comparing melt fracture percentage;

FIG. 2 is an optical photograph of melt fracture in a linear low density polyethylene sample using an optical microscope using TNPP in the formulation; and

FIG. 3 is an optical photograph of melt fracture in a linear low-density polyethylene sample using an optical microscope using a polymeric phosphite formulation (Example #1) in the formulation.

### DETAILED DESCRIPTION OF THE INVENTION

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

As further used in this application, the term “polymer” or “synthetic polymer” includes, but is not limited to: polymers of monoolefins and diolefins such as polyethylene, polypropylene, polyoisobutylene, poly-1-butene, poly-4-methylpentene, polyisoprene, polybutadiene, for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), and polymers of cycloolefins such as cyclopentene and norbornene, and blends of the polymers described above.

Copolymers of monoolefins and diolefins with each other or with other vinyl monomers such as ethylene/propylene, propylene/1-butene, propylene/isobutene, propylene/butadiene, ethylene/1-butene, ethylene/1-hexene, ethylene/1-octene, isobutylene/isoprene, ethylene/alkylacrylates, ethylene/alkylmethacrylates, ethylene/vinyl acetate, ethylene/acrylic acid (and salts, ionomers, thereof), terpolymers of ethylene, propylene, and dienes such as hexadiene, dicyclopentadiene, and ethylene-norbornene.

In general, the polymeric phosphites of this invention are added to the organic material to be stabilized in amounts from about 0.001 wt % to about 5 wt % of the weight of the organic material to be stabilized. A more preferred range is from about 0.01% to 2.0%. The most preferred range is from 0.025% to 1%.

While the present invention has been directed to just a few stabilized polymer compositions which are primarily polyolefins, there is no need to limit it to such. In fact, any of the polymers known in the art are useful in this invention, a non-exhaustive and non-limiting list including polyesters, polyurethanes, polyalkylene terephthalates, polysulfones, polyimides, polyphenylene ethers, styrenic polymers, polycarbonates, acrylic polymers, polyamides, polyacetals, halide-containing polymers and polyolefin homopolymers and copolymers. Additionally, included would be mixtures of different polymers, such as polyphenylene ether/styrenic resin blends, polyvinylchloride/ABS or other impact modified polymers, such as methacrylonitrile containing ABS, and polyester/ABS or polyester plus some other impact modifier may also be used. Such polymers are available commercially or may be made by means well known in the art. However, the phosphites of the invention are particularly useful in thermoplastic polymers, such as polyolefins, polyvinyl chlorides, polydiene rubbers, particularly polybutadiene rubbers, and styrenic polymers.

Polymers of mono-olefins and di-olefins, for example would include polypropylene, polyisobutylene, polybutene-1, polymethylpentene-1, polyisoprene or polybutadiene, as well as polymers of cycloolefins, for instance of cyclopentene or norbornene, polyethylene (which optionally can be crosslinked), for example high density polyethylene (HDPE), low density polyethylene (LDPE) and linear low density polyethylene (LLDPE) may be used. Mixtures of these polymers, for example mixtures of polypropylene with polyisobutylene, polypropylene with polyethylene (for example PP/HDPE), may also be used. Also useful are copolymers of mono-olefins and di-olefins with each other or with other vinyl monomers, such as, for example, ethylene/propylene, LLDPE and its mixtures with LDPE, propylene/butene-1, ethylene/hexene, ethylene/ethylpentene, ethylene/heptene, ethylene/octene, propylene/butadiene, isobutylene/isoprene, ethylene/alkyl acrylates, ethylene/alkyl methacrylates, ethylene/vinyl acetate (EVA) or ethylene/acrylic acid copolymers (EAA) and their salts (ionomers) and terpolymers of ethylene with propylene and a diene, such as hexadiene, dicyclopentadiene or ethylidene-norbornene; as well as mixtures of such copolymers and their mixtures with polymers mentioned above, for example polypropylene/ethylene-propylene copolymers, LDPE/EVA, LDPE/EAA, LLDPE/EVA and LLDPE/EAA. Also included in this list would be rubbers or elastomers such as natural cis-1,4-polyisoprene rubber, synthetic cis-1,4-polyisoprene rubber, 3,4-polyisoprene rubber, styrene/butadiene copolymer rubbers, butadiene/acrylonitrile copolymer rubbers, isoprene/butadiene copolymer rubbers, styrene/isoprene/butadiene terpolymer rubbers, cis-1,4-polybutadiene rubbers, 1,3-polybutadiene rubbers as well as mixtures of such polymers and copolymers and their mixtures with polymers mentioned.

Thermoplastic polymers may also include styrenic polymers, such as polystyrene, poly-(p-methylstyrene), poly-(a-methylstyrene), copolymers of styrene or a-methylstyrene with dienes or acrylic derivatives, such as, for example, styrene/butadiene, styrene/acrylonitrile, styrene/alkyl methacrylate, styrene/maleic anhydride, styrene/butadiene/ethyl acrylate, styrene/acrylonitrile/methacrylate; mixtures of high impact strength from styrene copolymers and another polymer, such as, for example, from a polyacrylate, a diene polymer or an ethylene/propylene/diene terpolymer; and block copolymers of styrene, such as, for example, styrene/butadiene/styrene, styrene/isoprene/styrene, styrene/ethylene/butylene/styrene or styrene/ethylene/propylene/styrene. Styrenic polymers may additionally or alternatively include graft copolymers of styrene or a-methylstyrene such as, for example, styrene on polybutadiene, styrene on polybutadiene-styrene or polybutadiene-acrylonitrile; styrene and acrylonitrile (or methacrylonitrile) on polybutadiene; styrene and maleic anhydride or maleimide on polybutadiene; styrene, acrylonitrile and maleic anhydride or maleimide on polybutadiene; styrene, acrylonitrile and methyl methacrylate on polybutadiene, styrene and alkyl acrylates or methacrylates on polybutadiene, styrene and acrylonitrile on ethylene/propylene/diene terpolymers, styrene and acrylonitrile on polyacrylates or polymethacrylates, styrene and acrylonitrile on acrylate/butadiene copolymers, as well as mixtures of with the styrenic copolymers indicated above.

Nitrile polymers are also useful in the polymer composition of the invention. These include homopolymers and copolymers of acrylonitrile and its analogs such as methacrylonitrile, such as polyacrylonitrile, acrylonitrile/butadiene polymers, acrylonitrile/alkyl acrylate polymers, acrylonitrile/alkyl methacrylate/butadiene polymers, acrylonitrile/butadiene/styrene (ABS), and ABS which includes methacrylonitrile.

Polymers based on acrylic acids, such as acrylic acid, methacrylic acid, methyl methacrylate acid and ethacrylic acid and esters thereof may also be used. Such polymers include polymethylmethacrylate, and ABS-type graft copolymers wherein all or part of the acrylonitrile-type monomer has been replaced by an acrylic acid ester or an acrylic acid amide. Polymers including other acrylic-type monomers, such as acrolein, methacrolein, acrylamide and methacrylamide may also be used.

Halogen-containing polymers may also be useful. These include resins such as polychloroprene, epichlorohydrin homopolymers and copolymers, polyvinyl chloride, polyvinyl bromide, polyvinyl fluoride, polyvinylidene chloride, chlorinated polyethylene, chlorinated polypropylene, fluorinated polyvinylidene, brominated polyethylene, chlorinated rubber, vinyl chloride-vinylacetate copolymer, vinyl chloride-ethylene copolymer, vinyl chloride-propylene copolymer, vinyl chloride-styrene copolymer, vinyl chloride-isobutylene copolymer, vinyl chloride-vinylidene chloride copolymer, vinyl chloride-styrene-maleic anhydride tercopolymer, vinyl chloride-styrene-acrylonitrile copolymer, vinyl chloride-isoprene copolymer, vinyl chloride-chlorinated propylene copolymer, vinyl chloride-vinylidene chloride-vinyl acetate tercopolymer, vinyl chloride-acrylic acid ester copolymers, vinyl chloride-maleic acid ester copolymers, vinyl chloride-methacrylic acid ester copolymers, vinyl chloride-acrylonitrile copolymer and internally plasticized polyvinyl chloride.

Other useful thermoplastic polymers include homopolymers and copolymers of cyclic ethers, such as polyalkylene glycols, polyethylene oxide, polypropylene oxide or copolymers thereof with bis-glycidyl ethers; polyacetals, such as polyoxymethylene and those polyoxymethylene with contain ethylene oxide as a comonomer; polyacetals modified with thermoplastic polyurethanes, acrylates or methacrylonitrile containing ABS; polyphenylene oxides and sulfides, and mixtures of polyphenylene oxides with polystyrene or polyamides; polycarbonates and polyester-carbonates; polysulfones, polyethersulfones and polyetherketones; and polyesters which are derived from dicarboxylic acid and diols and/or from hydroxycarboxylic acids or the corresponding lactones, such as polyethylene terephthalate, polybutylene terephthalate, poly-1,4-dimethyliol-cyclohexane terephthalate, poly-[2,2,4-(4-hydroxyphenyl)-propane] terephthalate and polyhydroxybenzoates as well as block copolyetheresters derived from polyethers having hydroxyl end groups.

Polyamides and copolyamides which are derived from diamines and dicarboxylic acids and/or from aminocarboxylic acids or the corresponding lactams, such as polyamide-4, polyamide-6, polyamide-6/6, polyamide-6/10, polyamide-6/9, polyamide-6/12, polyamide-4/6, polyamide-11, polyamide-12, aromatic polyamides obtained by condensation of m-xylene, diamine and adipic acid; polyamides prepared from hexamethylene diamine and isophthalic and/or terephthalic acid and optionally an elastomer as modifier, for example, poly-2,4,4-trimethylhexamethylene terephthalamide or poly-m-phenylene isophthalamide may be useful. Further copolymers of the aforementioned polyamides with polyolefins, olefin copolymers, ionomers or chemically bonded or grafted elastomers; or with polyethers, such as for instance, with polyethylene glycol, polypropylene glycol or polytetramethylene glycols, and polyamides or copolyamides modified with EPDM or ABS may be used.

Film production is one of the largest and most important applications for polyolefins. Process aids are often included to coat the die surface to improve the film production. These process aids improve the surface of the films and the production process by preventing melt fracture. Melt fracture is a phenomenon where the surface of the polymer will form bands of varying thickness and texture. This is caused by the polymer slipping and sticking to the surface of the die at certain shear and temperature ranges. The inclusion of process aids allows the melt fracture to clear up at a faster rate during startup and allows the equipment to run at higher production speeds to produce more product.

It has been found that certain polymeric polyphosphites when used in combination with these polymeric process aids can enhance these effects and act as a synergist. In addition, it has also been found that these polymeric process aids may be used at lower use levels when in combination with these polymeric polyphosphites thereby lowering the formulation costs for the film producer.

The present invention is directed to novel liquid polymeric polyphosphites of the general structure I as stabilizers for polymers during processing.

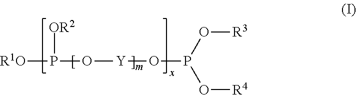

wherein
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group.

The present invention is also directed to novel copolymeric polyphosphites of the general structure II as stabilizers for polymers during processing.

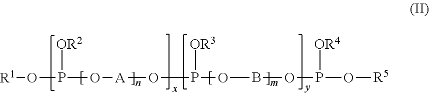

wherein
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O-B are C₃₋₂₀ alkyl glycol ethers, at least one of x or y is an integral value no less than 7; and further wherein
no more than two of R¹, R², R³, R⁴ and R⁵ are terminated with an hydroxyl group.

The present invention is also directed to the novel cycloaliphatic polyphosphite and copolyphosphites of U.S. Pat. No. 8,981,042 and patent application US 2014/0378590 and have the general Structure III.

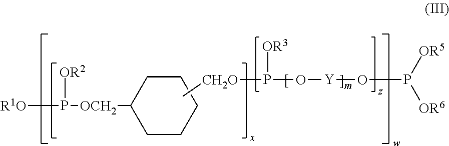

where each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₃₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000.

The below examples illustrate the performance advantages when using the polymeric process aids in combination with a polymeric phosphite.

### EXAMPLE #1

PPG 400 (95 g, 0.237 mol), triphenyl phosphite (73 g, 0.235 mol), a mixture of lauryl and myristyl alcohol with a hydroxyl number of about 280, (47 g, 0.235 mol), and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over a course of 1 hour. The reaction contents were held at 170-172° C. under the vacuum for 2 hours at which point no more phenol was distilling out. The vacuum was then broken by nitrogen and the crude product was cooled to 50° C. The product was a clear, colorless liquid.

### EXAMPLE 2

PPG 400 (48 g, 0.12 mol), triphenyl phosphite (73 g, 0.235 mol), lauryl alcohol, (47 g, 0.235 mol), dipropylene glycol (16 g 0.12 mol) and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over a course of 1 hour. The reaction contents were held at 170-172° C. under the vacuum for 2 hours at which point no more phenol was distilling out. The vacuum was then broken by nitrogen and the crude product was cooled to 50° C. The product was a clear, colorless liquid.

### EXAMPLE 3

1,6 hexane diol (57 g, 0.48 mol), triphenyl phosphite (150 g, 0.48 mol), a mixture of lauryl and myristyl alcohol with a hydroxyl number of about 280, (97 g, 0.48 mol), and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over a course of 1 hour. The reaction contents were held at 170-172° C. under the vacuum for 2 hours at which point no more phenol was distilling out. The vacuum was then broken by nitrogen and the crude product was cooled to 50° C. The product was a hazy, colorless liquid.

### EXAMPLE 4

The apparatus in Example #1 was used. 100 grams (0.69 mol) of cyclohexane dimethanol, triphenyl phosphite (237 g, 0.76 mol), a mixture of lauryl and myristyl alcohol with a hydroxyl number of about 280, (190 g, 0.95 mol), and and 0.4 grams of potassium hydroxide were added. The mixture was mixed well and heated to approximately 150° C. under nitrogen and held at the temperature for 1 hour. The pressure was then gradually reduced to 0.3 mm Hg and the temperature was increased to 180° C. over a course of 1 hour. The reaction contents were held at 180° C. under the vacuum for 2 hours at which point no more phenol was distilling out. The vacuum was then broken by nitrogen and the crude product was cooled to ambient temperature. The product was a non-viscous liquid.

### EXAMPLE 5

The apparatus in Example #1 was used. 20 grams (0.14 mol) of cyclohexane dimethanol, 7 g polypropylene glycol 400 (0.02 m), triphenyl phosphite (100 g, 0.32 mol), a mixture of lauryl and myristyl alcohol with a hydroxyl number of about 280 (136 g, 0.69 mol) and 0.4 grams of potassium hydroxide were added. The mixture was mixed well and heated to approximately 150° C. under nitrogen and held at the temperature for 1 hour. The pressure was then gradually reduced to 0.3 mm Hg and the temperature was increased to 180° C. over a course of 1 hour. The reaction contents were held at 180° C. under the vacuum for 2 hours at which point no more phenol was distilling out. The vacuum was then broken by nitrogen and the crude product was cooled to ambient temperature. The product was a non-viscous liquid.

Characteristics of the various synthesized additives may be characterized at least in part by the following tables.

TABLE I

| | Example | | | | |
|---|---|---|---|---|---|
| | #1 | #2 | #3 | #4 | #5 |
| appearance | liquid | liquid | liquid | liquid | liquid |
| Acid Value | 0.01 | 0.05 | 0.01 | 0.01 | 0.01 |
| (“AV”) | | | | | |
| (initial) | | | | | |
| % P | 4.9 | 5.9 | 8.9 | 7.6 | 6.0 |
| Avg. MW | 9,111 | 7,250 | 31,515 | 13,957 | 1,651 |

The following examples are meant to illustrate the benefits of the current invention over conventional phosphites. They are not intended to cover every single application which these could be used.

### EXAMPLE 6

### Blown Film

A blown film trial was run to compare the performance of the polymeric phosphites to the performance of a standard phosphite such as TNPP and an oligomeric (dimeric) phosphite such as 4,4′-butylidene-bis(6-tert-butyl-3-metylphenyl-ditridecyl phosphite), shown below.

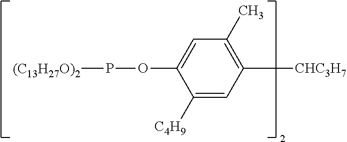

All phosphites were loaded into the polymer at 1800 ppm along with 700 ppm of the PPA. The blown film was produced according to the conditions: Die Gap: 50 mil; Blow up ratio: 2:5:1; Film thickness: 1-1.5 mil; and Output: 250 lbs/hr.

The film line was run at conditions in which the film would initially exhibit 100% melt fracture across the surface. Each formulation was monitored for 50 min. to see which formulations cleared the quickest. The amount of melt fracture remaining was monitored visually every 10 min.

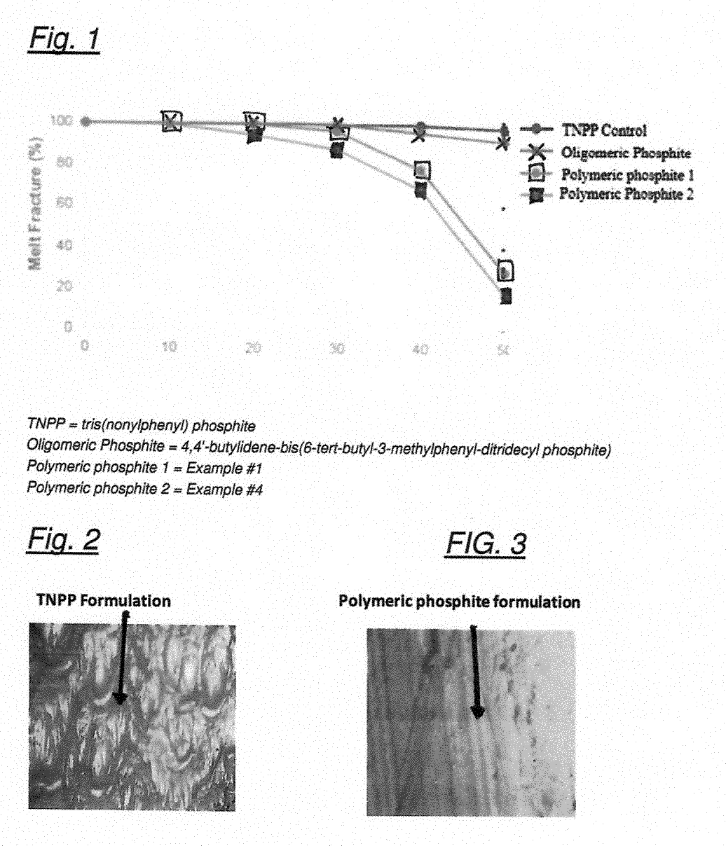

After 50 min the blown film containing the two polymeric phosphite was nearly free of melt fracture whereas the TNPP and oligomeric (dimeric) formulations showed only a very slight improvement in the amount of melt fracture. See FIG. 1 in which the tris(nonylphenyl) phosphite showed no improvement; the oligomeric (dimeric) phosphite, namely 4,4′-butylidene-bis(6-tert-butyl-3-methylphenyl-ditridecyl phosphite) also showed essentially no improvement, while the polymeric polyphosphite of Example #1 and the polymeric polyphosphite of Example #4 illustrated a very significant improvement.

This synergy between the polymeric phosphite and the process aid would offer an advantage to the film producer by allowing them to start up their equipment faster and produce quality film faster than with a conventional phosphite.

### EXAMPLE 7

### Time to Clear Ribbon Die

20 mil film was produced on an 18 mm lab Brabender using a ribbon die attachment. The extruder was run at conditions that would produce film with 100% melt fracture at start up. Formulations containing the polymeric process aid and two phosphites were compared to see how long each of these would take to clear the melt fracture. Polymeric phosphite 1 was compared to TNPP after 30 minutes of run time on the extruder. The amount of melt fracture remaining was compared by the appearance of the film under magnification.

The polymeric polyphosphite 1 (Example #1) had completely cleared the melt fracture in 30 min. while the formulation containing TNPP still showed 100% melt fracture. This indicates that the polymeric phosphites aid in coating the process aid on the extruder die and would allow for a film line to start up faster when using the polymeric polyphosphite.

### EXAMPLE 8

### Lower Use Levels of PPA

The polymeric polyphosphite was evaluated to see if it could perform as well as a standard phosphite even with reduced loading levels of the PPA. 20 mil film was produced on an 18 mm lab Brabender using a ribbon die attachment. The extruder was run at conditions that would produce film with 100% melt fracture at start up. Formulations containing 1800 ppm of each phosphite were evaluated. The formulation with TNPP had 700 ppm of the PPA while the formulation containing the polymeric phosphite contained only 350 ppm of the PPA.

The amount of melt fracture was estimated by visually examining the films after 30 min, 60 min, and 90 after startup of the extrusion process. The Polymeric Phosphite 1 (Example #1) exhibited lower melt fracture at all time intervals compared to the TNPP even with half of the loading level of the PPA.

TABLE II

| | | % Melt | % Melt | % Melt |
|---|---|---|---|---|
| | | Fracture | Fracture | Fracture |
| Phosphite | PPA Level | 30 Min | 60 Min | 90 Min |
| TNPP | 700 ppm | 60 | 40 | 25 |
| Polymeric | 350 ppm | 50 | 10 | <5 |
| Phosphite 1 | | | | |
| (Example #1) | | | | |

### EXAMPLE 9

### Increased Production Output

The polymeric phosphite was evaluated vs. the standard phosphite TNPP to see if it could allow increased run rates while avoiding melt fracture. The two phosphites were loaded at 1800 ppm with 700 ppm of the PPA. A 20 mil film was produced on an 18 mm lab Brabender using a ribbon die attachment. The extruder was run at conditions that would produce film with 100% melt fracture at start up. Each formulation was run until the melt fracture had completely cleared when the extruder as operated at 10 RPMS. The RPMS were then increased for each until melt fracture was seen on the surface of the film. The polymeric phosphite allowed the extruder to be operated at higher RPMS therefore increasing the production output vs. TNPP. The formulation containing the polymeric phosphite was able run up to 45 RPMS before any melt fracture was observed on the surface of the film. The TNPP formulations began to exhibit melt fracture between 25-30 RPMs. Therefore, the polymeric phosphite was just as effective at a 50% increase in run rate vs. TNPP. This would allow a film manufacture to run their equipment at higher rates and thus increasing their film out with adding costly equipment.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

1. A process to improve melt fracture resistance during melt processing of a synthetic polymer comprising the step of adding at least one homopolymer polyphosphite or copolymer polyphosphite of Formulas (I), (II) or (III) to the synthetic polymer: 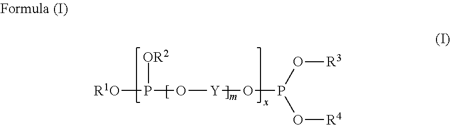
wherein
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 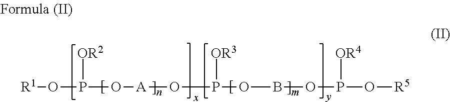
wherein
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O-B are C₃₋₂₀ alkyl glycol ethers, at least one of x or y is an integral value no less than 7; and further wherein
no more than two of R¹, R², R³, R⁴ and R⁵ are terminated with an hydroxyl group; or 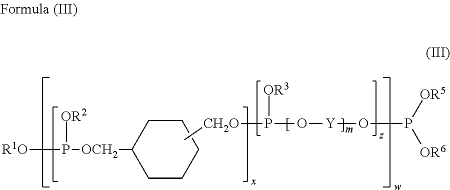
where each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

2. The process of claim 1 wherein
the synthetic polymer is a selected from the group consisting of polyesters, polyurethanes, polyalkylene terephthalates, polysulfones, polyimides, polyphenylene ethers, styrenic polymers, polycarbonates, acrylic polymers, polyamides, polyacetals, polydiene rubbers, halide-containing polymers, polyolefin homopolymers, polyolefin copolymers and mixtures and blends thereof.

3. The process of claim 1 wherein
the synthetic polymer is selected from the group consisting of polyphenylene ether/styrenic resin blends, polyvinylchloride/ABS, methacrylonitrile containing ABS and polyester/ABS resins.

4. The process of claim 2 wherein
the synthetic polymer is selected from the group consisting of polyolefins, polyvinyl chlorides and polybutadiene rubbers.

5. The process of claim 4 wherein
the synthetic polymer is a polyolefin selected from the group consisting of polyethylene and polypropylene.

6. The process of claim 5 wherein
the synthetic polymer is linear low-density polyethylene.

7. The process of claim 1 wherein
the polyphosphite of Formulas (I), (II) or (III) is added in an amount of from 0.001 wt. % to 5 wt. %.

8. The process of claim 7 wherein the polyphosphite of Formulas (I), (II) or (III) is added in an amount of from 0.01 wt. % to 2 wt. %.

9. The process of claim 8 wherein
the polyphosphite of Formulas (I), (II) or (III) is added in an amount of from 0.025 wt. % to 1 wt. %.

10. The process of claim 1 wherein the step of adding at least one homopolymer polyphosphite is Formula (I): 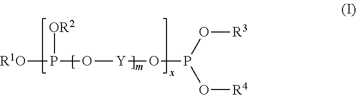
wherein
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group.

11. The process of claim 1 wherein the step of adding at least one copolymer polyphosphite is Formula (II): 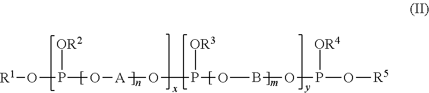
wherein
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O-B are C₃₋₂₀ alkyl glycol ethers, at least one of x or y is an integral value no less than 7; and further wherein
no more than two of R¹, R², R³, R⁴ and R⁵ are terminated with an hydroxyl group.

12. The process of claim 1 wherein the step of adding at least one copolymer polyphosphite is Formula (III): 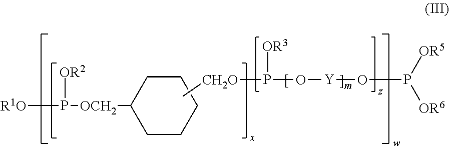
wherein
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20; and
w is an integral value ranging from 1 to 1,000.
